(19) United States
(12) Patent Application Publication
(10) Pub. No.: US 2025/0054741 A1
(43) Pub. Date: Feb. 13, 2025

(54) MASS SPECTRUM DATA PROCESSING

(71) Applicant: LUXEMBOURG INSTITUTE OF SCIENCE AND TECHNOLOGY (LIST), Esch/Alzette (LU)

(72) Inventors: Hung Quang HOANG, Esch/ALzette (LU); Rathaiah PURETI, Esch/ALzette (LU); Olivier BOUTON, Esch/ALzeite (LU); Tom WIRTZ, Esch/ALzeite (LU)

(21) Appl. No.: 18/710,242

(22) PCT Filed: Nov. 18, 2022
(86) PCT No.: PCT/EP2022/082428

§ 371 Date: May 15, 2024

(30) Foreign Application Priority Data
Nov. 18, 2021 (EP) 21209126.8
Dec. 14, 2021 (LU) LU501014

(51) Int. Cl. H01J 49/00

(52) U.S. Cl. CPC H01J 49/0009; H01J 49/0036

(57) ABSTRACT

A method for processing mass spectral data that has, for example, been obtained using a mass spectrometry device comprising deflection beams for scanning an ion beam over an area spanning the vertical direction of a microchannel plate focal plane detector, in order to increase the count rate of the detector. The method allows to efficiently combine ion counts that are detected on different areas of the focal plane detector, as a result of different deflection voltages being applied to the corresponding ion beams. Even though such beams also suffer unwanted deflections along the horizontal axis of the focal plane detector, the present method allows to re-align ion counts efficiently and to register them with accurate mass-to-charge ratios, which results in increased mass resolution power of the resulting combined mass spectrum.

### TECHNICAL FIELD

The invention lies in the field of charged particle detection methods. In particular, it relates to a method for processing mass spectral data obtained using a high-performance apparatus for detecting charged particles, which finds application among others in Mass Spectrometry, including Secondary Ion Mass Spectrometry, SIMS.

### BACKGROUND OF THE INVENTION

Mass spectrometry is an analytical technique that is commonly used to determine the elements that compose a molecule or sample. A mass spectrometer typically comprises a source of ions, a mass separator and a detector. The source of ions may for example be a device that is capable of converting the gaseous, liquid or solid phase of sample molecules into ions, that is, electrically charged atoms or molecules. Several ionization techniques are well known in the art, and the particular structure of an ion source device will not be described in any detail in the present specification. Alternatively, the ions to be analyzed by the mass spectrometer may result from the interaction between the sample in its gaseous, liquid or solid phase and an irradiation source, such as a laser, ion or electron beam. The ion-emitting sample is in that case considered to be the source of ions.

The ion beam that originates at the ion source is analyzed using a mass analyzer, which is capable of separating, or sorting, the ions according to their mass-to-charge ratio. The ratio is typically expressed as m/z, wherein m is the mass of the analyte in unified atomic mass units, and z is the number of elementary charges carried by the ion. The Lorentz force law and Newton's second law of motion in the non-relativistic case characterize the motion of charged particles in space. Mass spectrometers therefore employ electrical fields and/or magnetic fields in various known combinations in order to separate the ions emanating from the ion source. An ion having a specific mass-to-charge ratio follows a specific trajectory in the mass-analyzer. As ions of different mass-to-charge ratios follow different trajectories, the composition of the analyte may be determined based on the observed trajectories. By analogy with an optical spectrometer, which allows generation of a spectrum of the different wavelengths comprised in a wave beam, the mass spectrometer allows for generating a spectrum of the different mass-to-charge ratios comprised in a sample.

Sector instruments are a specific type of mass analyzing instrument. A sector instrument uses a magnetic field or a combination of an electric and magnetic field to affect the path and/or velocity of the charged particles. In general, the trajectories of ions are bent by their passage through the sector instrument, whereby light and slow ions are deflected more than heavier and fast ions. Magnetic sector instruments generally belong to two classes. In scanning sector instruments, the magnetic field is changed, so that only a single type of ion is detectable in a specifically tuned magnetic field. By scanning a range of field strengths, a range of mass-to-charge ratios can be detected sequentially. In non-scanning magnetic sector instruments, a static magnetic field is employed. A range of ions may be detected in parallel and simultaneously. The known non-scanning magnetic sector instruments are typically classified as Mattauch-Herzog type mass spectrometers.

A Mattauch-Herzog type mass analyzer consists of an electrostatic sector, ESA, followed on the ion trajectories by a magnetic sector. The arrangement of the electrostatic sector and the magnetic sector typically allows to disperse a wide range of mass-to-charge ratios m/z along the exit plane of the magnetic sector. All the ion masses are focused on a focal plane located at the exit plane (in the original Mattauch-Herzog configuration), or at a distance from the exit plane of the magnetic sector. Most of the known Mattauch-Herzog type mass spectrometers are able to operate in the double focusing condition (achromatic mass filtering) for the highest mass resolving power. A typical mass resolving power from hundreds to thousands are achieved.

One interesting features of this mass spectrometer architecture is its capability to capture simultaneously a wide range of the mass spectrum, provided that it is equipped with an appropriate detection system, ideally comprising a focal plane detector. A focal plane detector is able to simultaneously acquire the full mass spectrum in a short acquisition time, typically in a fraction of a second. This simultaneous acquisition capability offers several benefits. Firstly, 100% duty cycle of the measurement can be achieved. This benefit can result in better detection limits, shorter acquisition times, as well as smaller sample sizes needed for the measurement since all the mass-to-charge ratio (m/z) peaks are collected at the same time. Secondly, the ability to simultaneously record the entire mass spectrum allows for using both continuous and pulsed ionization techniques. In particular, the pulsed ionization techniques such as laser ablation/ionization commonly introduce rapid changes in the spectrum signal and therefore sequential detection techniques would cause errors in the measurements. Finally, the fully parallel acquisition capability reveals the possibility of post data analysis and mining of the complete chemical information of the sample rather than having to select certain mass ranges to be detected prior to the analysis.

An ideal focal plane detector for mass spectrometry should be sensitive enough to detect a single ion while the count rate of its single pixel (local count rate) should be more than 108 counts per seconds, cps, in order to handle the highest ion beam currents. In practice, a local count rate of more than 105 to 106 cps/mm² is typically required. Furthermore, the local dynamic range (defined by the signal range in which the detector responds linearly to the detected signal) is also required to be 10⁵-10⁶ in order to accurately measure a wide range of chemical concentrations.

Traditional detection systems typically comprise at least one microchannel plate, MCP, unit. A typical microchannel plate, MCP, is composed of 10⁴ to 10⁷ miniature electron multipliers whose typical diameters are in the range from 10 to 100 μm. Each channel acts as an individual electron multiplier, which can detect a single ion, electron, atom, molecule or photon. The MCP is typically fabricated from a high resistive material such as lead glass. The front side and rear side of the MCP are metallized electrodes to which a typical voltage difference of about 1000V is applied through appropriate biasing means, such as a source of electricity. When a single energetic particle hits a channel surface, it creates one or more secondary electrons, which are accelerated into an MCP channel by the applied voltage. Each of these secondary electrons can release two or more secondary electrons when hitting the channel wall again. This process is cascaded along the channel. Therefore, a single energetic particle hitting a channel creates a cascade of electron emission along the channel, resulting in an electron cloud of at least 10⁴ electrons at the output of the channel. An anode placed behind the MCP can electronically detect the electron cloud to register each single event hitting the MCP. An MCP assembly may comprise a single microchannel plate, or a stacked assembly thereof.

Traditional MCP-based focal plane detectors are however plagued by several limitations. A limited local count rate results in the detection signal being saturated for high concentration species. Typical MCPs limit the local count rate to 10³-10⁴ cps/mm². A limited local dynamic range results in poor detectable concentration range of the species. Mass spectrometry typically requires a wide range of dynamic range up to greater than 10⁵-10⁶. Although the overall dynamic range of known MCP devices is typically greater than 10⁷, the local dynamic range that it allows is hundreds to thousands of times smaller (10³-10⁴).

The above two limitations of traditional MCP-based technologies are mainly due to the fact that each MCP channel is limited by a maximum count rate that it can handle, and therefore the maximum local count rate and local dynamic range of one detector pixel are dependent on the number of MCP channels involved in the pixel. Each MCP channel is typically characterized by a dead time of several milliseconds between two detection events and therefore the maximum count rate that a MCP channel can handle is limited to less than 10² cps. Depending on the size of MCP channel, the density of the MCP is typically from 10³ to less than 10⁴ channels/mm². Considering the statistics for avoiding multiple ions hitting the same channel, the maximum count rate of a single MCP is limited to maximum 10⁵ cps/mm² or less. This limited count rate is typically worse in the MCP stack configurations, where two or three MCPs are joined together in order to improve the overall gain. In this case, a single particle hitting a channel of the first MCP can result in a dead time for several channels of the following MCP plates involved in the detection of this single particle. Therefore, the achievable maximum count rate in such known architecture is much less than 10⁴-10⁵ cps/mm², and the local dynamic range is much less than 10⁴ (considering a minimum signal to noise ratio that is larger than 3).

It has been proposed to improve such traditional MCP-based focal plane detectors by using charged particle beam deflection means upstream of the focal plane detector. In the scenario of a magnetic sector-based mass spectrometer device, ion beams that exit the mass analyzer and that are therefore dispersed along an axis, X, in accordance with their respective mass-to-charge ratios, then enter into a beam deflector. The beam deflector changes the propagation direction along a direction Z that is perpendicular to X, so that a corresponding spot on the focal plane detector is illuminated by the beam. Ideally, by using appropriate sequential deflection voltages, for any position along the axis X, a corresponding ion beam can be scanned along the perpendicular direction Z on the focal plane. An MCP-based focal plane detector is thereby illuminated successively at different spots in the Z direction, avoiding any saturation of MCP channels corresponding to a given area along the Z direction. As a result, the detected ion count rate of the focal plane detector is increased.

It has however been observed that an ion beam is not only deflected along the Z (vertical)direction, but also suffers an additional deflection along the X (horizontal) direction. On the focal plane detector, ion counts for at a given mass-to-charge ratio therefore possibly interfere with the counts of ion beams having neighboring mass-to-charge ratios. The additional deflection along the X direction depends on the deflection voltage that is used to deflect the beam along the Z axis, and on the considered mass-to-charge ration, i.e., on the position of the ion beam along the X axis. The result is a curved footprint of detected counts on the focal plane detector, typically showing a C- or crescent shape. Overall, considering all deflection steps along the Z axis for a given ion beam, the spread of corresponding ion counts in the horizontal X direction is thus increased. Using traditional data processing of so collected mass spectral data, the obtained mass resolving power is severely reduced compared to scenarios where no deflection along the Z axis is used, but wherein the ion counts are inherently limited due to periodic MCP saturation.

### Technical Problem to be Solved

It is an objective of the invention to present a data processing method which overcomes at least some of the disadvantages of the prior art. In particular, it is an objective of the invention to provide a method for obtaining mass spectrum data at an elevated mass resolving power, based on data sets comprising ion counts along two dimensions of a focal plane detector.

### SUMMARY OF THE INVENTION

In accordance with a first aspect of the invention, a data processing method for obtaining mass spectrum data of a sample if proposed. The method comprises the steps of:
providing, in a memory element, a plurality of data sets obtained by analyzing said sample using a mass spectrometer device comprising a magnetic sector instrument for dispersing ion beams carrying ions of said sample along a first direction X in accordance with their ion mass-to-charge ratios, and that defines a focal plane extending in the first direction X and along a second direction Z that is perpendicular to said first direction, ion beam deflection means for deflecting, along the second direction Z, ion beams that exit said magnetic sector instrument, and further comprising ion detection means arranged along said focal plane, wherein each data set indicates detected ion counts at a plurality of positions along said first direction X;
for each data set, providing calibration data of the mass spectrometer device in a memory element, wherein the calibration data associates positions along said main direction of the focal plane in a given data set, to corresponding ion mass-to-charge ratios;
using data processing means, generating a calibrated data set for each of said data sets, by mapping the detected ion counts at each position in a data set to a corresponding ion mass-to-charge ratio, using the corresponding calibration data;
using data processing means, for each ion mass-to-charge ratio, combining the mapped ion counts of each calibrated data set, thereby generating accumulated mass spectrum data of said sample.

Preferably, the step of providing a plurality of data sets may comprise:
setting a deflection voltage of the ion deflection means;
deflecting, along the Z direction, ion beams that exit said magnetic sector instrument and that are dispersed along the first direction X, before said ion beams reach the ion detection means;
collecting the resulting detected ion counts in a data set, which is associated with said deflection voltage and/or with an area of the ion detection means, on which they were counted;
repeating the two previous steps at least once by setting different deflection voltages of the ion deflection means.

The step of providing a plurality of data sets may preferably comprise:
initializing an empty bulk data set;
setting a deflection voltage of the ion deflection means;
deflecting, along the second direction Z, ion beams that exit said magnetic sector instrument and that are spread along the first direction X, before said ion beams reach the ion detection means;
collecting the resulting detected ion counts in said bulk data set;
repeating the two previous steps at least once by setting different deflection voltages of the ion deflection means;
partitioning the bulk data set into a predetermined number of data sets, wherein each data set comprises all ion counts that have been detected in a partition spanning the focal plane along the first direction X.

Preferably, each partition may span a predetermined height along the second direction Z of the focal plane.

The different deflection voltages may preferably follow an incremental pattern, so that their successive application results in said ion beams scanning the focal plane along the second direction Z.

The pattern may preferably be repeated at a frequency in the range from 1 kHz to 5 kHz, preferably from 1 kHz to 3 kHz.

Preferably, a detected ion count within a data set at a position along the first direction X of the focal plane may be obtained by counting all detected ion counts at said position, along the second direction Z of the focal plane.

The calibration data may preferably comprise mass dispersion coefficients.

The data processing method may preferably further comprise the steps of identifying locations of peaks in said mass spectrum data, and determining the mass resolution of said mass spectrum data based on the peak widths and their relative positions.

In accordance with a further aspect of the invention, a system for determining mass spectrum data of a sample if provided. The system includes a mass spectrometer device, which comprises
a magnetic sector instrument for dispersing ion beams carrying ions of said sample along a first direction X in accordance with their ion mass-to-charge ratios, and defining a focal plane extending in the first direction X and along a second direction Z that is perpendicular to said first direction;
ion detection means having a detection front arranged on said focal plane and comprising the entry face of at least one microchannel plate, MCP, assembly, wherein the entry face extends along said second direction Z, wherein the MCP assembly is configured for receiving an ion beam that impinges on its entry face and for generating, for each impinging charged particle, a corresponding amplified detection signal on its opposite exit face,
at least one read-out anode extending along said X and Z directions for collecting said amplified detection signals in at least one data set indicating detected ion counts at a plurality of positions along said first direction X, the anode being arranged at a distance to, and in parallel with the exit face of said at least one MCP assembly,
ion beam deflection means arranged downstream of the magnetic sector instrument at a distance of said entry face and configured for selectively deflecting an incoming ion beam along the second direction Z, so that the corresponding charged particles selectively reach different portions of the MCP assembly's entry face along said second direction (Z);
   wherein the system further comprises a controlling device for controlling said ion beam deflection means, and data processing means configured to execute the method in accordance with aspects of the invention on the at least one collected data set.

In accordance with a further aspect of the invention a computer program is provided, comprising computer readable code means, which, when run on a computer system, causes the computer system to carry out the method in accordance with aspects of the invention.

According to a final aspect of the invention, a computer program product is provided, comprising a computer readable medium on which the computer in accordance with aspects of the invention is stored.

The proposed invention provides a method for processing mass spectral data that has, for example, been obtained using a mass spectrometry device comprising deflection beams for scanning an ion beam over an area spanning the vertical (Z) direction of an MCP focal plane detector, in order to increase the count rate of the detector. The method allows to efficiently combine ion counts that are detected on different areas of the focal plane detector, as a result of different deflection voltages being applied to the corresponding ion beams. Even though such beams also suffer unwanted deflections along the horizontal (X) axis of the focal plane detector, the present method allows to re-align ion counts efficiently and to register them with accurate mass-to-charge ratios, which results in increased mass resolution power of the resulting combined mass spectrum. The advantages of a detection device that increases detected ion counts using a beam deflector can therefore be reaped without sacrificing the obtained mass resolving power.

### BRIEF DESCRIPTION OF THE DRAWINGS

Several embodiments of the present invention are illustrated by way of figures, which do not limit the scope of the invention, wherein:

FIG. 1 is a workflow showing main steps of a preferred embodiment of the method in accordance with the invention;

FIG. 2 is an illustration of a detector as used in a device for obtaining mass spectral data sets;

FIG. 3 is a lateral cut through a detector as used in a device for obtaining mass spectral data sets, including beam deflection means;

FIG. 4 is an illustration of controlling means as used in a device for obtaining mass spectral data sets;

FIGS. 5a-5h show mass spectral data sets and results obtained using known data processing methods;

FIG. 6 shows a workflow of a preferred embodiment of the method in accordance with the invention;

FIGS. 7a-7f show mass spectral data sets and results obtained using a preferred embodiment of the method in accordance with the invention;

FIGS. 8a-8c show mass spectral data sets and results obtained using a preferred embodiment of the method in accordance with the invention;

FIG. 9 shows a workflow of a preferred embodiment of the method in accordance with the invention;

FIGS. 10a-10f show mass spectral data sets and results obtained using a preferred embodiment of the method in accordance with the invention;

### DETAILED DESCRIPTION OF THE INVENTION

This section describes features of the invention in further detail based on preferred embodiments and on the figures, without limiting the invention to the described embodiments. Unless otherwise stated, features described in the context of a specific embodiment may be combined with additional features of other described embodiments.

The description puts focus on those aspects that are relevant for understanding the invention. It will be clear to the skilled person that a device for obtaining mass spectral data also comprises other commonly known aspects, such as for example an appropriately dimensioned power supply, or a mechanical holder frame for holding the various elements of the apparatus in their respectively required positions, even if those aspects are not explicitly mentioned.

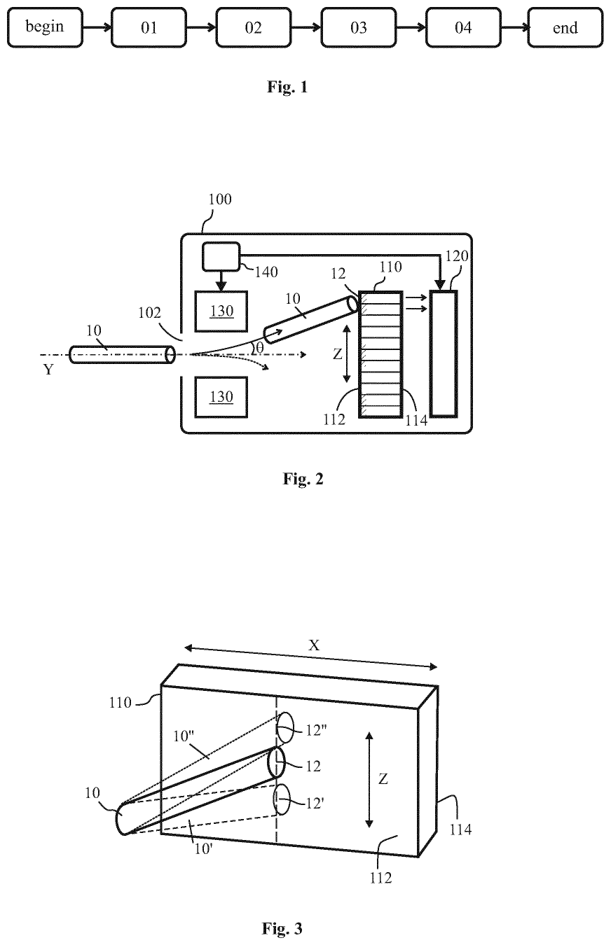

FIG. 1 illustrates main steps of the data processing method for obtaining mass spectrum data of a sample in accordance with a preferred embodiment of the invention.

At a first step 01, a plurality of data sets is provided in a memory element. The data sets have been obtained by analyzing the sample, using a mass spectrometer device comprising a magnetic sector instrument for dispersing ion beams carrying ions of said sample along a first direction X in accordance with their ion mass-to-charge ratios. The magnetic sector instrument defines, at a distance of its exit plane, a focal plane extending in the first direction X and along a second direction Z that is perpendicular to said first direction. The mass spectrometer device further comprises ion beam deflection means for deflecting, along the second direction Z, ion beams that exit said magnetic sector instrument, and further comprises ion detection means arranged along said focal plane. Each of the data sets provided in the memory element indicates detected ion counts at a plurality of positions along said first direction X, but possibly at different area slices along the second direction Z.

At step 02, calibration data of the mass spectrometer device is provided in a memory element, wherein the calibration data associates positions along said main direction of the focal plane in a given data set, to corresponding ion mass-to-charge ratios. The calibration data may depend on the area slice along the second direction Z, so that for a given position along the direction X, a plurality of calibration data may be provided, depending on the position in the Z dimension, or on other parameters.

At step 03, a calibrated data set is generated by data processing means having read access to said memory elements. For each of the provided data sets, the detected ion counts at each position in a data set are mapped to, or associated with, a corresponding ion mass-to-charge ratio, using the corresponding calibration data.

At step 04, using the data processing means, for each ion mass-to-charge ratio, the mapped ion counts of each calibrated data set are combined, for example by summing them together, thereby generating accumulated mass spectrum data of said sample.

Without being limited to a specific data acquisition setup, the data sets which are used as an input to the proposed data processing method, may by way of example be acquired using a setup as schematically illustrated in FIGS. 2 and 3.

FIG. 2 illustrates charged particle beam 10. By way of a non-limiting example, the beam may correspond to an ion beam exiting the magnetic filtering sector of a mass spectrometer. The ion beam hits a charged particle detector 110 that would typically extend along the focal plane of the mass spectrometer in the direction indicated by the letter X. The detector's front 112 is comprised of entry faces of channels of a microchannel plate, MCP, assembly. The channels are used to amplify the detected ions that enter them into a measurable detection signal that is generated on the corresponding exit face 114. In known MCP-based detectors, the ion beam 10 (solid lines) always hits the detector 110 on the same spot 12 along the Z direction, which is perpendicular direction to the X direction. The 1D pixel size along the detector in the X-direction does not depend on the active width of the detector in the vertical direction Z. The wider the active width in the Z-direction is, the larger the number of the channels potentially contained in one 1D pixel. A typical ion beam in a magnetic sector mass spectrometry instrument is well focused onto a small spot size of few hundreds pm in the X-direction by a few thousands μm (typically less than 2000 μm) in the Z-direction. The beam therefore typically hits only a part of the active width of the detector in the Z-direction, resulting in a limited actual number of amplifying channels in each 1D pixel involved in detecting the ion beam.

If the ion beam 10, 10′, 10″ is scanned along the Z-direction (see the dotted lines in FIG. 1) within the active width of the MCP as illustrated, the total number of the actual MCP channels involved in the detection of the ion beam are significantly increased and therefore the detectable maximum local count rate and dynamic range is significantly improved while keeping the same detector 1D resolution in the X-direction. As the spot 12, 12′, 12″ illuminates different parts of the detector's front 114 at different times, the aggregated active width of the MCP in the Z-direction (vertical) involved in this detection process can be extended to more than 20 mm, resulting in at least an order of magnitude of improvement as compared to previously known detectors. This helps to improve the local count rate and dynamic range by more than an order of magnitude compared to the case according to which the ion beam is not scanned on the MCP assembly's front face 114. This scanning mechanism also helps to further reduce the probability for multiple ions hitting the same channel, and therefore to further improve the detection efficiency of the MCP detector assembly. However, an ion beam is not only deflected along the Z (vertical) direction, but also suffers an unwanted additional deflection along the X (horizontal) direction due to electric fringe fields of the means that are used for deflecting the beam along the Z direction and due to the possible inclination angle between the beam at the main direction in which the deflection means extend. On the focal plane detector 110, ion counts for at a given mass-to-charge ratio therefore possibly interfere with the counts of ion beams having neighboring mass-to-charge ratios. The additional deflection along the X direction depends on the deflection voltage that is used to deflect the beam along the Z axis, and on the considered mass-to-charge ration, i.e. on the position of the ion beam along the X axis. The result is a curved footprint 12, 12′, 12″ of detected counts on the focal plane detector, typically showing a C- or crescent shape.

FIG. 3 provides a schematic lateral cut view of a detection apparatus 100 in that is useful for obtaining data sets as required by the invention. The detection apparatus 100 comprises an opening or inlet 102 through which a beam 10 carrying charged particles such as ions or cluster ions is able to enter the apparatus. The beam may for example be an ion beam that has been filtered using a magnetic sector instrument. In the example that is illustrated, an incoming charged particle beam 10 travels along direction Y towards the inlet. Beam deflection means 130 are arranged downstream of the inlet. The beam deflection means may comprise deflection plates, a device of the Bradbury-Nielsen Gate type, or other units known in the art for selectively acting on the direction of the charged particle beam's direction. Depending on the selected magnitude of deflection, which is controlled by a control unit 140, the charged particle beam 10 that traverses the deflection means is deflected by a corresponding deflection angle θ with respect to its initial propagation direction Y. The deflection angle is typically a function of the strength of the electromagnetic field in which the charged particle beam evolves while traversing the deflection means 130. Once the charged beam 10 exits the deflection means, it continues its deviated trajectory in a straight line, the entire apparatus being contained in a vacuum enclosure that is not illustrated. Further downstream of the deflection means 130, a microchannel plate, MCP, assembly 110 is arranged. The MCP assembly comprises a plurality of microchannels forming a detection front 112, for receiving the charged particle beam. Depending on the deflection angle θ, the spot generated by the beam on the detection front 112 illuminates a different set of channels 12 along the Z direction. For each charged particle entering a channel, a corresponding amplified electrical signal is generated on the exit face 114 of the detector. These detection signals are collected by at least one read-out anode 120, which is arranged at a distance to, and in parallel with the exit face 114 of the MCP assembly. The read-out anode 120 is operatively coupled to data processing means, which are not illustrated, and ideally also controlled by said control unit 140. The data processing means are configured for storing the detection counts provided by the read-out anode, preferably together with their respective detection locations on the anode and/or on the detection front and optionally together with the deflection voltage or deflection angle that was used when the corresponding counts were detected, in a memory element and/or for further processing the recorded data.

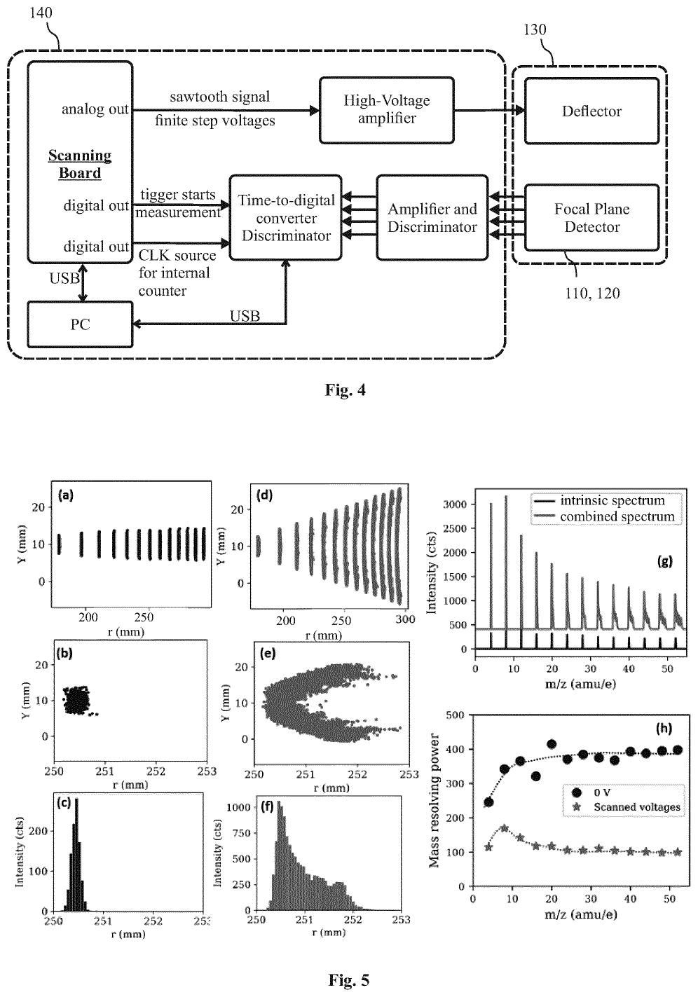

FIG. 4 provides a schematic illustration of a control unit 140, which may by way of example be used to control the voltages of the detector assembly 110, 120 and to obtain the signal rate from the assembly. A low-power high voltage operational amplifier scans the voltage of the ion deflector 130 with a scan rate in the range from 1 Hz to 10 kHz. The scanning signal, which is preferably a periodic sawtooth-like signal, consists of a combination of multiple scans of step voltages. The number of voltage steps depends on the size of the ion beams and the required deflection length of the ion beams in the vertical axis of the detector. The number of voltage steps may be obtained experimentally and depends on the parameters of each particular setup. In a simple case, the ratio of the required deflection length and the mean beam size along the vertical axis would provide the number of voltage difference steps and the relation between Z and X provides the list of the voltage steps. In a preferred embodiment, for a required deflection length of 20 mm on the detection front and a deflection potential between the deflection plates spanning the range from −1200 to 1200 V (preferably implemented by applying opposite sign voltages of the same nominal value between 0 and +/−600V to each deflection plate), the preferred voltage steps are 11 in number, with a step width of approximately 120 V. In general, for the state-of-the-art MCP detectors, the dead time (no-response time) of a channel is around 10-20 ms. This means that if an ion hits a channel, of a single MCP, it initiates a cascade of electrons and the surface of the channel becomes electrons free until it replenished with the electronic charges. The hits in this period would not generate any electron cascades as such the hits will be undetected by the detector. Therefore, to avoid any hits in the duration of a channel's dead time, the scan period of a cycle can be fixed to around 10-20 ms. In this case, the scan frequency is of about 50-100 Hz and is an approximate value for a single channel. In practice, ion beams cover a large group of channels ranging from 100 to 1000 channels as such the effective dead time of the channels is in the range from 10⁻⁴ to 10⁻⁵ s. By considering the ion beam statistics, i.e. a large flux lies in the middle of the distribution, the number of channels that get saturated is in the range from 10-100 per an ion beam as such the dead time ranges from 10⁻³ to 10⁻⁴ s. In this regard, the scan frequency applied to the deflection voltage steps should be greater than 100 Hz, and preferably it should be at least 1 kHz. A larger signal rate (>1 kHz) is desirable to achieve an enhanced signal count rate of the detector. When a measurement starts, the scanning board sends a scanning signal to the high-voltage amplifier, and the starting of the scanning signal synchronizes with the starting trigger of the Time-to-digital converter, TDC. Each time the step voltage changes, a pulse will pass to the TDC on a second line to increase an internal counter. During the acquisition, the data processing means illustrated by the personal computer, PC, collect data from the TDC. The raw data has a format of {x position, y position, number of the voltage step, and iteration of the scan}. Two-dimensional position information of ion count events is therefore obtained, together with the associated scan iteration and voltage step number, from which the absolute deflection voltage may be derived. After multiple scans, there may be an integration time on each mass spectrum (1D histogram) at different step voltages to combine all the mass spectra.

FIG. 5 shows positional information of all the ions detected in the focal plane of a mass spectrometer. For the case of 0 V on the deflection means (no deflection), FIG. 5a shows the positional coordinates of all the ions. FIG. 5b shows the positional information for the reference mass 28 amu, and FIG. 5c shows the corresponding histogram of the intensity counts vs horizontal position (r). For the case of the scanned deflector's potential difference in ranging from −1200 to 1200 V, FIG. 5d shows the positional coordinates of the ions, exhibiting a crescent-shaped and mass-to-charge ratio dependent footprint. FIG. 5e shows the positional information for the reference mass of 28 amu, and FIG. 5f shows the corresponding histogram. In FIG. 5g, mass spectra derived for the case of 0 V and the case of scanning potentials are shown in comparison: the intrinsic spectrum without voltage scanning and the combined spectrum in accordance with the invention are shown, the latter is offset by 410 counts for easier viewing. A comparison between the mass resolving powers that are extracted from the spectra shown in the FIG. 5g is shown in FIG. 5h.

The spatial distribution of the ions in the focal plane is considered as a single profile (spectrum) irrespective of the potential difference that was applied to the beam deflector when the ion counts were detected. This leads to interference in terms of the spatial distribution of charged particles having neighboring mass-to-charge ratios, as their footprints on the detector spread our horizontally (compare FIG. 5e to FIG. 5b). This kind of interference affects the mass resolution of the mass spectrometer severely. In the conventional processing of the data obtained from the magnetic-sector mass spectrometer, peak widths and peak positions of the ion beams from the as-obtained data are vital to convert the positional information into the mass scale and to derive the mass resolving power of mass spectrometer. As-obtained positional information of the ions for the case of 0 V and the scanning potential difference is in the range from −1200 to 1200 V are shown in FIGS. 5(a-c) and FIG. 5(d-f) respectively. The derived mass spectrum for the two (the top one is for the scanned case of the accumulated spectrum and the bottom one is for the 0 V case) cases is shown in FIG. 5(g). In the case of the scanned voltages, the width of the peaks is increasing with the increasing m/z value compared to the 0 V case. For instance, for the reference of 28 amu/e, the positional information is shown in scattered and histogram plots in FIG. 5(b-c) and FIG. 5(e-f) respectively. From these figures, it becomes apparent that the width of the peak (ion beam) in the case of the scanned voltages is much larger than in the case of the 0 V. The deteriorating mass resolving power with m/z in the case of the scanned voltages compared to the case of 0V in FIG. 5(h) is linked to the increased peak width with increasing m/z. The mass resolving power increases with increasing m/z as observed in the case of 0 V but the opposite trend in the case of the scanned voltages indicates that the conventional approach to process the as-obtained mass spectrum provides poor mass resolving powers. Moreover, peak finding algorithms that are used to pick the peaks of a spectrum may pick more false peaks because of a set of local peaks with a considerable height can be existed as seen in FIG. 5(f).

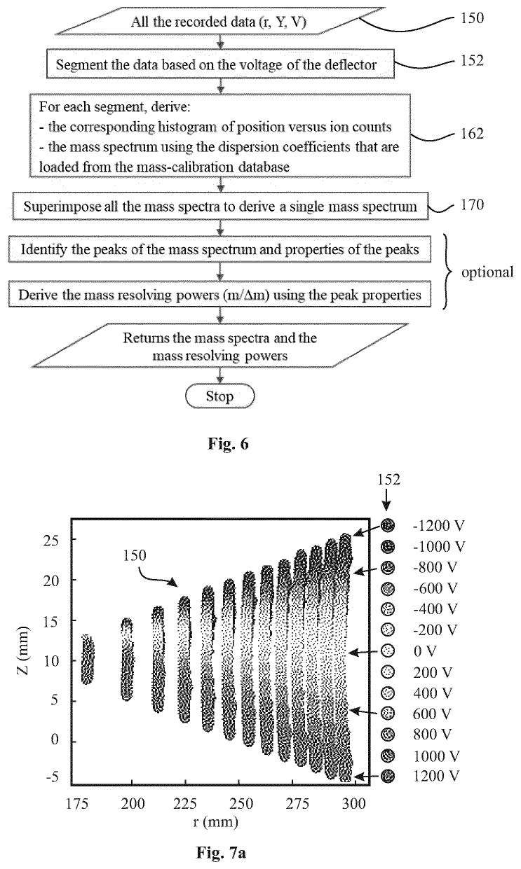

FIG. 6 outlines a data processing method in accordance with a preferred embodiment, which aims at avoiding these drawbacks, using similar input data sets. Referring to step 01 of the method, as previously described and as illustrated in FIG. 1, the mass spectral data 150 is provided in a plurality of data sets 152, which were obtained when the ion beam was scanned along the detection front using the deflection means. The resulting detected ion counts are recorded in a data set 152, which is associated with the used deflection potential difference and/or with an area of the ion detection means, on which they were counted. In step 02, calibration data for each so-generated data set is provided. In step 03, the ion counts in each data set 152 are registered to the respective mass-to-charge ratios using their respectively associated calibration data, while in step 04, the resulting calibrated data 160 of all data sets 162 is combined to generate accumulated mass spectrum data 170. Optionally, peaks in the mass spectrum, and properties thereof may be identified, and the corresponding mass resolving power can be determined based on the detected peaks.

The scanning voltage value for each detected ion's positional information (r along the X axis, Z, V) is recorded in each data set. Therefore, each data set 152 or deflection/scanning voltage defines a segment or partition of the total recorded data 150 in the focal plane of the mass spectrometer device.

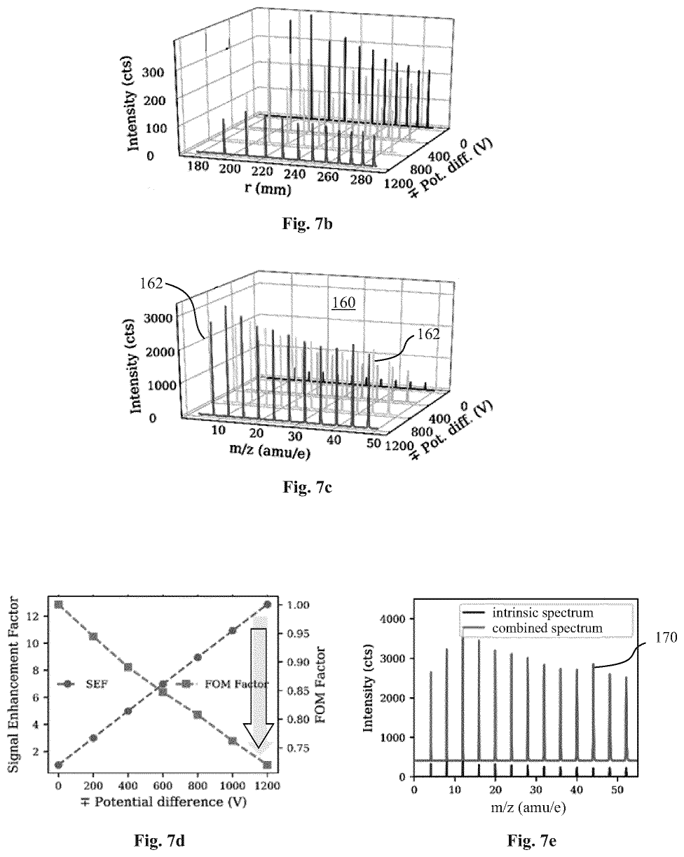

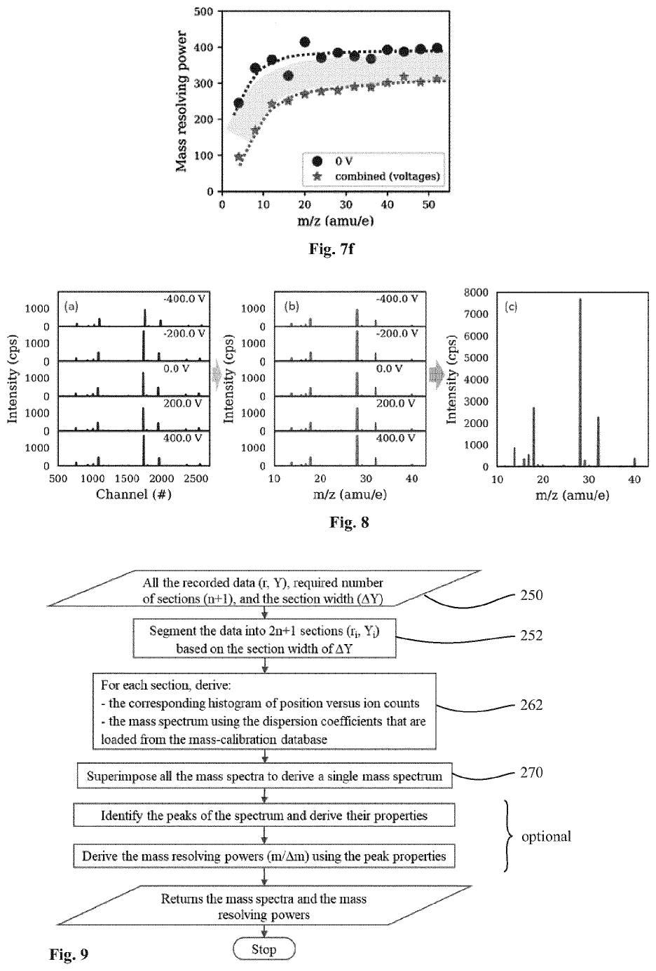

The positional information of the ions in the focal plane of the mass spectrometer with the scanning voltages is shown in FIG. 7a. When the voltage difference of the deflection means varies from −1200 V to +1200, the ions are deflected from the top part of the focal plane detector to the bottom part of the deflector. Here, all the acquired data 150 is composed by one dataset 152 per deflection voltage. As the curved profiles are in symmetric in the Z-direction, the ions positions corresponding to the +V and −V may be mixed together and the segments are labelled with ±V. The positional information from the each of the segments is converted into a histogram of events and is shown in FIG. 7b. With the known m/z values and peak positions, the position scale of each histogram is converted into m/z scale using the corresponding calibration data, and thus a mass spectrum 162 for each voltage segment, i.e. each data set, ±V is generated until all data 160 has been calibrated. With the increasing peak-to-peak voltage step from 0 V to ±V, the mass spectra 162 are progressively superimposed by considering the m/z scale of the spectrum of the 0 V to obtain a single mass spectrum 170 up to the voltage difference of ±1200 V (see FIG. 7c). This allows to derive a trade-off curve between the mass resolving power (Figure of merit, FOM factor) and the signal enhancement factor, SEF, with respect to the voltage of the deflector. The derived SEF and FOM factors in relative to the case of 0 V is shown in FIG. 7d. The SEF is increasing with the voltage of the detector while the FOM factor is decreasing as expected. The FOM for the case of the ±1200 V is of about 750% as compared to the case of the 0 V while the signal enhancement factor is 12 times larger compared to the case of 0V. In non-illustrated simulation runs, FOM of about 80-90% as compared to the case of no deflection have been observed. The mass resolving power is therefore not massively impacted by using the proposed beam scanning technique in conjunction with the proposed data processing. The mass spectra corresponding to 0 V and the combined data sets of the scanned voltages are shown in FIG. 7e: the intrinsic spectrum without voltage scanning and the combined spectrum in accordance with the invention are shown, the latter is offset by 410 counts for easier viewing. The corresponding mass resolving power of the MS with increasing m/z is shown in FIG. 7f. At all the masses, the mass resolving power from the combined spectrum is observed to be within 75% of the case of the 0 V. The deterioration can be ascribed to the increased peak widths of the combined spectrum as a result of the residual horizontal deflection of the ions with increasing voltage of the deflector. If the deflection of the ions is not symmetric in y-direction, which can be expected if the optical axis of the ions is not in the middle of the defector or if there is any misalignment of the deflector plates, then the steps from the histogram derivation to superposition of the mass spectrum can be performed based on individual potential differences, or equivalently individual data sets, i.e., from −1200 to +1200 instead of from 0 to ±V.

FIGS. 8a-8c provide another illustration of this method. FIG. 8a shows the spectra of intensity versus channel number for different scan voltages (voltage on a plate of the deflector and the other plate of the deflector biased to opposite polarity of the same value), this corresponds to a plurality of originally provided data sets 152, 152′, . . . at step 01. FIG. 8b shows the mass spectra corresponding to the spectra of FIG. 8a, this corresponds to the calibrated data sets 162, 162′, . . . at step 03. FIG. 8c shows the single mass spectrum 170 that derived by combining the spectra shown in FIG. 8b, as provided after step 04 of the method in accordance with the invention. The following algorithm may be used to implement the method in accordance with this embodiment:
INPUT: Positional information (r, Z, V) of the ions in the focal plane of the mass spectrometer along with the scanning potential differences.
Step 1: Segment the data into sub-data sets based on the scanning potential difference of the deflector.
Step 2: Convert the positional information of each sub-data set into a histogram of position vs counts
Step 3: Derive the mass spectrum from the histogram of position vs counts for each section
   Load the calibration data comprising mass dispersion coefficients (a and b in the relation d a a\sqrt{m}+b) from the mass-calibration database
   Convert the histogram of position vs counts into a histogram of mass vs count (mass spectrum) Step 4: Superimpose the mass spectra progressively, based on the mass-to-charge ratio, m/z, values, starting from the segment of −V to +V.
   Set the section to second value of the list of section numbers
   Set the m/z values of the section 0 as the reference m/z values
      WHILE section maximum value of the list of the section numbers DO
         Appends the data from previous section and to the data of the current section
         Sorts the appended data based on the m/z scale
         Sets the mass value to second value of the reference m/z values
         WHILE mass ≤maximum value of the reference m/z values DO
         Filters the ion counts where their m/z values lie in between the previous and current mass
         Sums the filtered ion counts and couples the sum to the current mass.
         Moves to the next mass value in the reference m/z values
         END WHILE
         Moves to the next section value in the list of section numbers
         END WHILE
   This results a single mass spectrum with m/z vs counts.
Step 5 (optional): Find the peaks of the mass spectrum and the properties of the peaks.
   Remove the pronounced background signal from the spectrum using a baseline correction algorithm
   Perform data smoothing to reduce the noise and thus to reduce the number of false peaks
   Identify the peaks (location of the peaks) of the mass spectrum using peak finding algorithm
Step 6 (optional): Derive the properties of the peaks by fitting them to the Lorentzian/Gaussian distribution.
Step 7 (optional): Derive the mass resolution using the peak widths and positions with the relation, m/Δm.
OUTPUT: Mass spectrum and mass resolving power

Additionally, the following method may be used to gather the required calibration data:
Use standard samples to obtain the histograms of the dispersed ions in the detector plane.
For each segment that is based on the voltage of the deflector:
   Identify the peaks and their locations (d) with respect to the known components (m) of the sample.
   Extract the mass dispersion coefficients (a and b from the mass dispersion relation d≈a \sqrt{m}+b).
   Save the values (a, b, m, d, and V) as calibration data for in a structured memory element such as a database.
Repeat the measurements by changing various parameters of the experiment.
   Extract of the mass dispersion coefficients.
   Derive the relations between the parameters and the mass dispersion coefficients.
   Save all the related coefficients corresponding to the parameters.

FIG. 9 outlines a data processing method in accordance with a preferred embodiment, which also aims at avoiding the previously mentioned drawbacks. Referring to step 01 of the method, as previously described and as illustrated in FIG. 1, the mass spectral data is provided in a plurality of data sets 252, which are obtained from a bulk data set 250. The bulk data set 250 comprises all aggregated positional information of detected ion counts, as gathered for all subsequently used deflection voltages or deflection steps. The bulk data set 250 is portioned, or equivalently portioned into 2n+1 horizontal slices, each forming a data set 252. In step 02, calibration data for each so-generated data set 252 is provided. In step 03, the ion counts in each data set 252 are registered to the respective mass-to-charge ratios using their respectively associated calibration data, which results in calibrated data sets 262. In step 04, the calibrated data 260 of all data sets 262 is combined to generate accumulated mass spectrum data 270. Optionally, peaks in the mass spectrum, and properties thereof may be identified, and the corresponding mass resolving power can be determined based on the detected peaks.

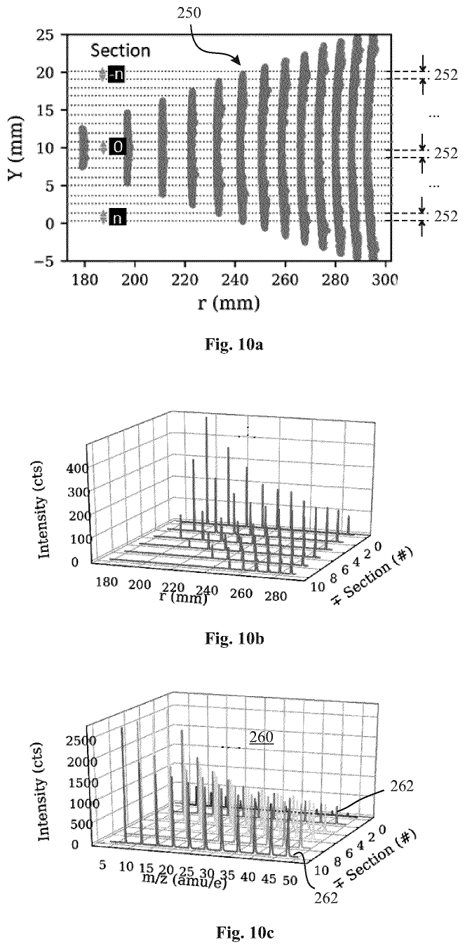

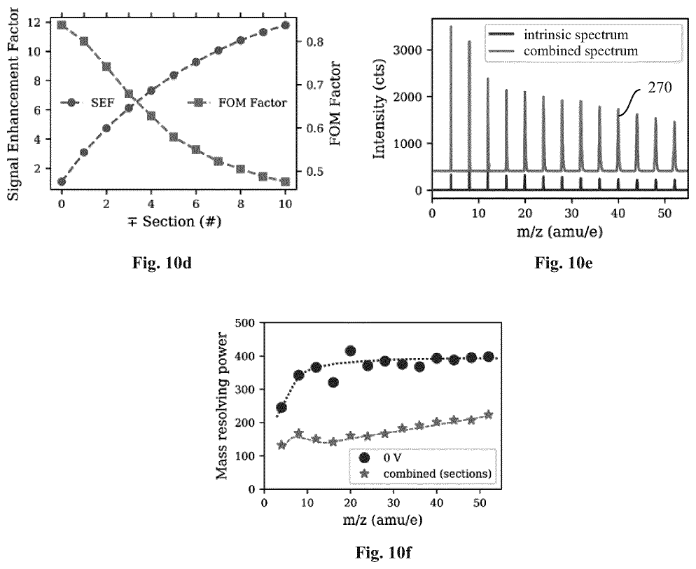

The bulk recorded data may 250 be split into 2n+1 partitions 252 starting from the minimum to maximum Z value of a reference m/z with a section or partition width of AY is equal to 1 mm (see FIG. 10a).

The schematic of the subsections of the data collected over a scan of the potential difference in the ranging from −1200 V to 1200 V is shown in FIG. 10a. As the required deflection length is 20 mm, with section width of 1 mm, the positional information is divided into 21 sections. As there is symmetry along the y-direction in the ion beam profiles, a pair of symmetrical sections is combined into a single section and the central section is noted as 0-section, and thus there is a total of 11 sections. Preferably, the number of sections may lie between 11 and 15. The positional information from each section is converted into a histogram of counts and is shown in FIG. 10b. With the known mass-to-charge ratio, m/z, values and peak positions, the position scale is converted into the mass-to-charge ratio (m/z) scale using the provided calibration data, and thus into a mass spectrum for each data set, section or partition, which reference the same concept. When section number increases from 0 to ±n, the mass spectra are progressively superimposed by considering the m/z scale of section 0 as a reference to obtain a combined mass spectrum (see FIG. 10c). This helps to derive the dependence of the signal enhancement factor, SEF, and the total mass resolution of all the m/z peaks (Figure of merit, FOM) on the number sections. The derived SEF and FOM factors relative to the case of 0 V are shown in FIG. 10d. The SEF is increasing with section number while the FOM factor is decreasing. The decrease in the FOM factor is linked to an increase in the peak width of the peaks with increasing mass to charge ratio m/z (see FIG. 10(e) for the case of the combined sections). In FIG. 10e, the intrinsic spectrum without voltage scanning and the combined spectrum in accordance with the invention are shown, the latter is offset by 410 counts for easier viewing. The mass resolving of the mass spectrometer seems to deteriorate up to 2 times in comparison the case of the 0 V (see FIG. 10f). This procedure still provides much better mass resolving powers compared to the conventional approach. The following algorithm may be used to implement the method in accordance with this embodiment:
INPUT: Positional information (r, Z) of the ions in the focal plane of the mass spectrometer, section width (ΔZ) and the required number of sections (2n+1).
Step 1: Divide the bulk data into, 2n+1, sections based on the Z values and section width (ΔZ)
Step 2: Convert the positional information of each section into a histogram of position vs counts
Step 3: For each section, derive the mass spectrum from the histogram of positions and counts
   Load the mass dispersion coefficients (a and b in the relation d a\sqrt{m}+b) from the mass-calibration database
   Use the mass dispersion relation and the coefficients to convert the positions (channels) of the ions into the corresponding m/z values. This results a spectrum of m/z vs counts.
Step 4: Superimpose the mass spectra progressively, based on the m/z values, starting from the first section to the last section.
   Set the section to second value of the list of section numbers
   Set the m/z values of the section 0 as the reference m/z values
   WHILE section maximum value of the list of the section numbers DO
      Appends the data from previous section and to the data of the current section
      Sorts the appended data based on the m/z scale
      Sets the mass value to second value of the reference m/z values
      WHILE mass ≤maximum value of the reference m/z values DO
         Filters the ion counts where their m/z values lie in between the previous and current masses
         Sums the filtered ion counts and couples the sum to the current mass.
         Moves to the next mass value in the reference m/z values
      END WHILE
      Moves to the next section value in the list of section numbers
   END WHILE
   This results a single mass spectrum with m/z vs counts.
Step 5 (optional): Find the peaks of the mass spectrum and the properties of the peaks.
   Remove the pronounced background signal from the spectrum using a baseline correction algorithm
   Perform data smoothing to reduce the noise and thus to reduce the number of false peaks
   Identify the peaks (location of the peaks) of the mass spectrum using peak finding algorithm
Step 6 (optional): Derive the properties of the peaks by fitting them to the Lorentzian/Gaussian distribution.
Step 7 (optional): Derive the mass resolution using the peak widths and positions with the relation, m/Δm.
OUTPUT: Mass spectrum and mass resolving power

Additionally, the following method may be used to gather the required calibration data:
Use the standard samples to obtain the histograms of the dispersed ions in the detector plane.
For each segment that is based on the segment/section number:
   Identify the peaks and their locations (d) with respect to the known components (m) of the sample.
   Extract the mass dispersion coefficients (a and b from the mass dispersion relation d≈a \sqrt{m}+b).
   Save the values (section number and vertical location of the section) as calibration data in a structured memory element, such as a database.
Repeat the measurements by changing various parameters of the experiment
   Extract of the mass dispersion coefficients.
   Derive the relations between the parameters and the mass dispersion coefficients.

Save all the related coefficients corresponding to the parameters.

In all embodiments, the data sets may optionally be pre-processed:

### Baseline Correction

The measurements that are performed at high-gain regions of the MCP detector, to achieve larger dynamic ranges, are often affected by the noise that is associated with the read-out electronics. In order to remove the distortion from the histogram, a simple baseline procedure may be used, without limiting the invention to this procedure. In this procedure, the ion counts data is split into small segments with a segment width of a few number of channels, and the minima in the intensity of all the channels in the segment will be chosen as a baseline point for that segment. In similar way, the baseline points of all the segments provides a baseline of the histogram (spectrum). In order to avoid the false baseline points, the width of the segment is chosen as twice the expected total width of a peak of the spectrum. For example, the segment width may be chosen as 26 channels.

### Data Smoothing

In order to reduce the high-frequency noise associated with the signal, the Savitzky-Golay, SG, filter may be used, in which the smoothing will be performed by fitting a polynomial to a filter window (w) of a certain data points as the window moves along all the points of the signal data.

A discrete Fourier transform may be used to reduce the high frequency noise associated with the signal. The Fourier transformation separates the input signal into components that contribute at discrete frequencies. The peaks of the spectrum tend to be in the low frequency range while the noise components to be in the high frequency range. In order to remove the high frequency components, a cut-off frequency is defined as a ratio between the number of data points (number of channels) and the minimum width of a peak of the spectrum. The inverse Fourier transformation of the frequencies that are less than the cut-off frequency provides a spectrum with reduced noise while the inverse Fourier transformation of the frequencies larger than the cut-off frequency results a noise associated with the original spectrum.

The comparison between the results of SG filter and FFT filter indicates that the SG filter can be a good choice for the data smoothing. However, if a spectrum is associated with a larger noise the combination of FFT (first) and SG filter (on the FFT-smoothed) will be helpful to reduce the noise impact on the spectrum for further processing.

### Peakfinding Algorithm

Finding accurate positions of the peaks of the ions counts spectrum obtained from the detector is useful to convert the spectrum of channel/position versus ion counts into a mass spectrum. Without limiting the invention thereto, a simple peak finding algorithm may be used.

As the SG filtered, smoothed data retains the shape of the peaks and reduces the high-frequency noise, at first, this simple algorithm finds the locations of all the peaks whose height is greater than a threshold value (minimum peak height). If the threshold value is set to a lower value, there may be a larger false peak. Often, the false peaks with lower peak heights could not find a proper fitting to the Gaussian or Lorentzian distribution. In order to remove the false peaks as well as to derive the features for each peak, this algorithm performs peak fitting for each peak over a predefined window length from the baseline corrected data (not the smoothed because the height of the peaks observed from the smoothed data is lower than the case of the baseline corrected data or as-obtained data).The constraints, minimum peak width and minimum peak width, can be varied in order to limit the false peaks.

### Composite Model of the Spectrum

The features, that are derived from the fitting of each peak, of all the peaks of the spectrum are used to derive a composite model for the ion counts spectrum. In order to do this, first a composite model is prepared by summing up the gaussian distribution function of all the (n) peaks. The number of parameters of this model turned to be n times the parameters of a single gaussian distribution function. The initial values of these parameters are takes from the peak properties that are derived in using the peak finding algorithm. Once the composite model is generated, model fitting for the baseline corrected data is performed and thus the best fit values are derived for all the parameters of the composite model.

### Mass Calibration of the Magnetic-Sector Mass Spectrometer

In magnetic-sector mass spectrometer, the detected signal in the focal plane of the mass spectrometer has a well-known mass dispersion relation xᵢ˜a\sqrt{mᵢ}+b, where xᵢ is the focal point (position) of an ion beam with mass-to-charge ratio mi/z in the focal plane (detector), and a and b are known as mass dispersion coefficients. As the channel number is proportional to the distance along the horizontal axis of the detector, the channel number can be used in order to fit the data of known mᵢ and xᵢ values as such to derive the coefficients. Once the coefficients are derived, they will be stored into the data base of the instrument. The coefficients can be loaded into data processing software and can be used to convert the convert the channel (position) scale to m/z scale and thus the measured positional into a corresponding mass spectrum. This procedure will be repeated for several voltages of the deflector plates and upload the corresponding calibrated, dispersion coefficients, values along with the voltage values to the database of the instrument.

Using the provided description and figures, a person with ordinary skills in computer programming will be able to implement the described methods in various embodiments without undue burden and without exercising inventive skill.

It should be understood that the detailed description of specific preferred embodiments is given by way of illustration only, since various changes and modifications within the scope of the invention will be apparent to the skilled person. The scope of protection is defined by the following set of claims.

1. A method for obtaining mass spectrum data of a sample, comprising the steps of:
providing, in a memory element, a plurality of data sets obtained by analyzing said sample using a mass spectrometer device comprising a magnetic sector instrument for dispersing ion beams carrying ions of said sample along a first direction in accordance with their ion mass-to-charge ratios, and that defines a focal plane extending in the first direction and along a second direction that is perpendicular to said first direction, ion beam deflection means for deflecting, along the second direction, ion beams that exit said magnetic sector instrument, and further comprising ion detection means arranged along said focal plane,
wherein each data set indicates detected ion counts at a plurality of positions along said first direction;
executing, on a computer:
for each data set, providing calibration data of the mass spectrometer device in the memory element, wherein the calibration data associates positions along said first direction of the focal plan in a given data set, to corresponding ion mass-to-charge ratios;
generating a calibrated data set for each of said data sets, by mapping the detected ion counts at each position in a data set to a corresponding ion mass-to-charge ratio, using the corresponding calibration data; and
for each ion mass-to-charge ratio, combining the mapped ion counts of each calibrated data set, thereby generating accumulated mass spectrum data of said sample.

2. The method according to claim 1, wherein the step of providing a plurality of data sets comprises:
setting a deflection voltage of the ion deflection means;
deflecting, along the second direction, ion beams that exit said magnetic sector instrument and that are dispersed along the first direction, before said ion beams reach the ion detection means;
collecting the resulting detected ion counts in a data set which is associated with said deflection voltage and/or with an area of the ion detection means, on which they were counted; and
repeating the two previous steps at least once by setting different deflection voltages of the ion deflection means.

3. The method according to claim 1, wherein the step of providing a plurality of data sets comprises:
initializing an empty bulk data set;
setting a deflection voltage of the ion deflection means;
deflecting, along the second direction, ion beams that exit said magnetic sector instrument and that are spread along the first direction, before said ion beams reach the ion detection means;
collecting the resulting detected ion counts in said bulk data set;
repeating the two previous steps at least once by setting different deflection voltages of the ion deflection means;
partitioning the bulk data set into a predetermined number of data sets, wherein each data set comprises all ion counts that have been detected in a partition spanning the focal plane along the first direction.

4. The method according to claim 3, wherein each partition spans a predetermined height along the second direction of the focal plane.

5. The method according to claim 2, wherein the different deflection voltages follow an incremental pattern, so that their successive application results in said ion beams scanning the focal plane along the second direction.

6. The method according to claim 5, wherein said pattern is repeated at a frequency from 1 kHz to 5 kHz.

7. The method according to claim 1, wherein a detected ion count within a data set at a position along the first direction of the focal plane is obtained by counting all detected ion counts at said position, along the second direction of the focal plane.

8. The method according to claim 1, wherein the calibration data comprises mass dispersion coefficients.

9. The method according to claim 1, further comprising the steps of identifying locations of peaks in said mass spectrum data, and determining the mass resolution of said mass spectrum data based on the peak widths and their relative positions.

10. A system for determining mass spectrum data of a sample, comprising
a mass spectrometer device, comprising
a magnetic sector instrument for dispersing ion beams carrying ions of said sample along a first direction in accordance with their ion mass-to-charge ratios, and defining a focal plane extending in the first direction and along a second direction that is perpendicular to said first direction,
ion detection means having a detection front arranged on said focal plane and comprising the entry face of at least one microchannel plate assembly, wherein the entry face extends along said second direction, wherein the microchannel plate assembly is configured for receiving an ion beam that impinges on its entry face and for generating, for each impinging charged particle, a corresponding amplified detection signal on its opposite exit face,
at least one read-out anode extending along said first direction and said second direction for collecting said amplified detection signals in at least one data set indicating detected ion counts at a plurality of positions along said first direction, the anode being arranged at a distance to, and in parallel with the exit face of said at least one microchannel plate assembly,
ion beam deflection means arranged downstream of the magnetic sector instrument at a distance of said entry face and configured for selectively deflecting an incoming ion beam along the second direction, so that the corresponding charged particles selectively reach different portions of the entry face of the microchannel Plate assembly along said second direction; wherein the system further comprises a controlling device for controlling said ion beam deflection means, and
data processing means configured to execute the method in accordance with claim 1 based on the at least one collected data set.

11. A computer program comprising computer readable code means, which, when run on a computer system, causes the computer system to carry out the method according to claim 1.

12. A computer program product comprising a computer readable medium on which the computer program according to claim 11 is stored.
